(19) United States
(12) Patent Application Publication
(10) Pub. No.: US 2014/0156782 A1
(43) Pub. Date: Jun. 5, 2014

(54) METHOD OF PROVIDING CONTENT DATA

(71) Applicant: AGILE COMMUNICATIONS EUROPE LIMITED, London (GB)

(72) Inventors: Roberto CIARLEGLIO, London (GB); John FORD, London (GB); Benjamin EDGE, Beckenham Kent (GB); Andrew Vladimir DOUGLAS, London (GB); Alykhan DHANAMI, Brighton (GB)

(73) Assignee: Agile Communications Europe Limited, London (GB)

(21) Appl. No.: 13/691,369

(22) Filed: Nov. 30, 2012

(51) Int. Cl. H04L 29/08

(52) U.S. Cl. CPC H04L 67/00
USPC 709/217

(57) ABSTRACT

A method of controlling provision of content data representative of at least one content item, including providing first content data representative of a first content item to the computing device, receiving first action data, processing the first action data with the content provision parameter data, determining a second part of the sequence, using data indicative of the assessed state of the computing device, providing the selected second content data to the computing device, receiving second action data indicative of an action at the computing device in relation to the second content data, processing the second action data with the content provision parameter data, and determining at least one further part of the sequence by determining whether the at least one content provision parameter is met or whether to select and provide the computing device with further content data representative of at least one further content item.

### TECHNICAL FIELD

The present invention relates to a method of providing content data, for example, but not exclusively, in an electronic education system.

### BACKGROUND

Electronic systems are known for providing content data, for example learning content data, to a user for education purposes.

In one example, a user may select a learning strategy from a number of different predetermined learning strategies. A preset sequence of structural elements to be displayed is used depending on a learning strategy selected at the outset of a learning course.

It is desirable to provide content data, for example educational content data, to a computing device more efficiently.

### SUMMARY

In accordance with embodiments, there is provided a computer implemented method of controlling provision to a computing device of content data representative of at least one content item, the content data being provided according to a sequence determined in accordance with content provision parameter data indicative of at least one content provision parameter, the sequence being determined in accordance with action data indicative of an action at said computing device in relation to content data provided during the sequence, the method including:

providing first content data representative of at least one first content item to the computing device, in accordance with a first part of said sequence;

receiving first action data indicative of an action at said computing device in relation to said first content data;

processing said first action data with the content provision parameter data to assess a state of said computing device in relation to the at least one content provision parameter;

determining a second part of the sequence, using data indicative of said assessed state of the computing device, by selecting second content data representative of at least one second content item,

providing said selected second content data to the computing device, in accordance with the second part of the sequence;

receiving second action data indicative of an action at said computing device in relation to said second content data;

processing said second action data with the content provision parameter data to assess further a state of said computing device in relation to the at least one content provision parameter; and

determining at least one further part of the sequence, using data indicative of said further assessed state of the computing device, by determining whether the at least one content provision parameter is met or whether to select and provide the computing device with further content data representative of at least one further content item.

In further embodiments, there is provided a computer implemented method of controlling provision of content data representative of at least one content item, the content data being provided according to a sequence determined in accordance with content provision parameter data indicative of at least one content provision parameter, the sequence being determined in accordance with action data indicative of an action at a computing device in relation to content data provided during the sequence, the method including:

receiving at the computing device first content data representative of at least one first content item, in accordance with a first part of said sequence;

providing first action data indicative of an action at said computing device in relation to said first content data;

receiving selected second content data, representative of at least one second content item, at the computing device in accordance with a second part of the sequence, the second part of the sequence having been determined by selecting the second content data using data indicative of an assessed state of the computing device, the assessed state of the computing device having been determined by processing said first action data with the content provision parameter data to assess a state of said computing device in relation to the at least one content provision parameter;

providing second action data indicative of an action at said computing device in relation to said second content data; and

receiving at the computing device selected further content data, representative of at least one further content item, if it has been determined to select and provide the further content data in accordance with at least one further part of the sequence, the at least one further part of the sequence having been determined using data indicative of a further assessed state of the computing device, the further assessed state of the computing device having been determined by processing said second action data with the content provision parameter data to assess further a state of said computing device in relation to the at least one content provision parameter.

In other embodiments, there is provided apparatus for controlling provision of content data representative of at least one content item, the apparatus comprising:

at least one processor;

and at least one memory including computer program instructions;

the at least one memory and the computer program instructions being configured to, with the at least one processor, cause the apparatus at least to perform:

a computer implemented method of controlling provision of content data representative of at least one content item, the content data being provided according to a sequence determined in accordance with content provision parameter data indicative of at least one content provision parameter, the sequence being determined in accordance with action data indicative of an action at a computing device in relation to content data provided during the sequence, the method including:

providing first content data representative of at least one first content item to the computing device, in accordance with a first part of said sequence;

receiving first action data indicative of an action at said computing device in relation to said first content data;

processing said first action data with the content provision parameter data to assess a state of said computing device in relation to the at least one content provision parameter;

determining a second part of the sequence, using data indicative of said assessed state of the computing device, by selecting second content data representative of at least one second content item,

providing said selected second content data to the computing device, in accordance with the second part of the sequence;

receiving second action data indicative of an action at said computing device in relation to said second content data;

processing said second action data with the content provision parameter data to assess further a state of said computing device in relation to the at least one content provision parameter; and

determining at least one further part of the sequence, using data indicative of said further assessed state of the computing device, by determining whether the at least one content provision parameter is met or whether to select and provide the computing device with further content data representative of at least one further content item.

In further embodiments, there is provided a computer program product comprising a non-transitory computer-readable storage medium having computer readable instructions stored thereon, the computer readable instructions being executable by a computerized device to cause the computerized device to perform a computer implemented method of controlling provision of content data representative of at least one content item, the content data being provided according to a sequence determined in accordance with content provision parameter data indicative of at least one content provision parameter, the sequence being determined in accordance with action data indicative of an action at a computing device in relation to content data provided during the sequence, the method including:

providing first content data representative of at least one first content item to the computing device, in accordance with a first part of said sequence;

receiving first action data indicative of an action at said computing device in relation to said first content data;

processing said first action data with the content provision parameter data to assess a state of said computing device in relation to the at least one content provision parameter;

determining a second part of the sequence, using data indicative of said assessed state of the computing device, by selecting second content data representative of at least one second content item,

providing said selected second content data to the computing device, in accordance with the second part of the sequence;

receiving second action data indicative of an action at said computing device in relation to said second content data;

processing said second action data with the content provision parameter data to assess further a state of said computing device in relation to the at least one content provision parameter; and

determining at least one further part of the sequence, using data indicative of said further assessed state of the computing device, by determining whether the at least one content provision parameter is met or whether to select and provide the computing device with further content data representative of at least one further content item.

Further features will become apparent from the following description of embodiments, given by way of example only, which is made with reference to the accompanying drawings.

### BRIEF DESCRIPTION OF THE DRAWINGS

FIG. 1 shows schematically a system for providing content data;

FIG. 2 shows schematically a computing device;

FIGS. 3A and 3B illustrate a method of controlling provision of content data;

FIG. 4 illustrates schematically a sequence according to an example;

FIG. 5 illustrates schematically a sequence according to a different example;

FIG. 6 illustrates schematically a group of content items provided in an example.

### DETAILED DESCRIPTION

In accordance with embodiments, there is provided a computer implemented method of controlling provision to a computing device of content data representative of at least one content item, the content data being provided according to a sequence determined in accordance with content provision parameter data indicative of at least one content provision parameter, the sequence being determined in accordance with action data indicative of an action at said computing device in relation to content data provided during the sequence, the method including:

providing first content data representative of at least one first content item to the computing device, in accordance with a first part of said sequence;

receiving first action data indicative of an action at said computing device in relation to said first content data;

processing said first action data with the content provision parameter data to assess a state of said computing device in relation to the at least one content provision parameter;

determining a second part of the sequence, using data indicative of said assessed state of the computing device, by selecting second content data representative of at least one second content item,

providing said selected second content data to the computing device, in accordance with the second part of the sequence;

receiving second action data indicative of an action at said computing device in relation to said second content data;

processing said second action data with the content provision parameter data to assess further a state of said computing device in relation to the at least one content provision parameter; and

determining at least one further part of the sequence, using data indicative of said further assessed state of the computing device, by determining whether the at least one content provision parameter is met or whether to select and provide the computing device with further content data representative of at least one further content item.

This method enables content data to be provided to a computing device efficiently. This is achieved by determining the sequence of providing the content data as the method progresses. Accordingly, an action, for example an input by a user, at the computing device in response to the provision of data representative of a particular content item is used to select data representative of a subsequently provided content item in the sequence. In this way, the sequence and therefore the content data provided can be tailored to a user's individual requirements and abilities. For example, where the content data is provided as an educational course, content data may be provided during the sequence in accordance with a pupil's evolving skills and abilities. Thus, content data may be provided efficiently, by reducing or eliminating the provision of irrelevant content data for a user's needs. With the selective approach of providing content data according to the sequence, less content data may be communicated to the computing device compared with known systems. Thus, communication channel resources for data communication, for example the bandwidth of a communications channel over a computer network, may be used more efficiently. This is notable for example for content data with a large data size, such as video content data.

Further, by reducing or eliminating the provision of irrelevant content data, an objective represented by the content provision parameter, for providing the content data, may be met more quickly. Further, where a group of users have a common objective represented by the content provision parameter, the sequence may be determined differently for each user, which improves the probability of each user in the group meeting the objective.

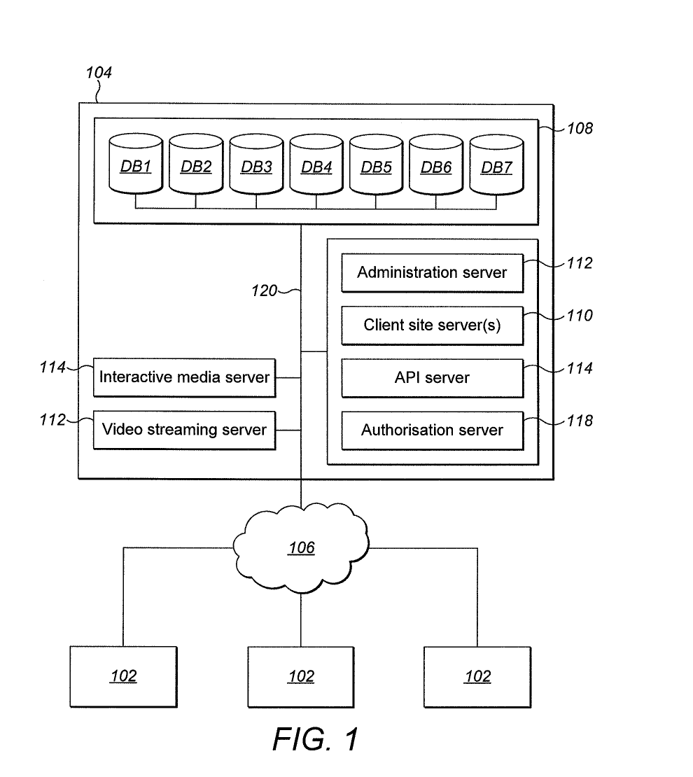

Examples of embodiments will now be described in detail. FIG. 1 is a schematic diagram showing an example system for providing a computer implemented method of controlling provision of content data to a computing device. Further details of embodiments of the method will be described below, after examples of the system have been described.

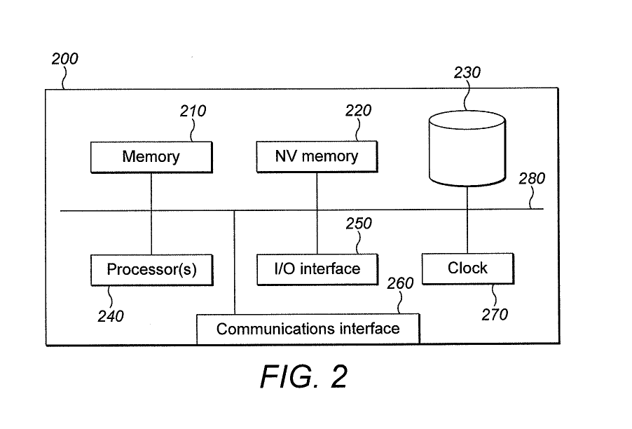

An example of internal components of such a computing device 102 is described below with reference to FIG. 2. According to one embodiment, at least one computing device 102 is connected to a content data provision platform 104, via a network 106, for example the Internet or a telecommunications network. In this example, the platform 104 comprises a database server 108, application servers 110, a video streaming server 112 for streaming video content data to a user and an interactive media server 114 which may be used if content data is to include interactive communications such as audio-visual video conferencing. The database server may for example be implemented using Microsoft® SQL Server 2008, the application servers may be implemented using Microsoft® Internet Information Services (IIS) and ASP.NET, the video streaming server and the interactive media server may be implemented using Adobe® Media Server 5 Professional. In further examples the video streaming server and/or the interactive media server may not be included.

The database server in this example comprises seven databases DB1, DB2, DB3, DB4, DB5, DB6, DB7, which will be described in further detail below.

The application servers 110 in this example comprise four servers configured to supply services of the platform to at least one of the computing devices 102. Thus, each computing device 102 may be considered a client device.

The four application servers in this example are an administration server 112, a client site server 114, an application programming interface (API) server 116 and an authorisation server 118. The API server may provide the functionality of parts of the platform 104 to third party computing devices, for example for incorporation into a third party computer application for a computing device. Further details of the services provided by the servers will be described below.

Each server is for example a computing device with internal components for example those described below using FIG. 2. The servers may comprise: separate computing devices coupled to one or more networks, for example one or more local area networks (LAN) or wide area networks (WAN); separate computer processing unit (CPU) and memory systems within a common physical architecture coupled together using a common systems bus; separate software components operating on a common hardware platform, for example a common set of CPUs and memory; a common software component with the described functionality; or any combination of these approaches. Further, even though each server may be functionally distinct, its functionality may be incorporated into a common program architecture.

For example, any of the database server, the administration server, the client site server, the API server, the authorisation server, the video streaming server and the interactive media server may be functional sub-components of a single server. For ease of explanation, it will be assumed that the servers of FIG. 1 are distinct entities coupled together by a content provision platform network 120.

FIG. 2 shows an example of a hardware architecture for a computing device 200 that may be used to implement one or more of the client devices 102 and servers described above. Computing device 200 comprises: volatile memory 210 such as Random Access Memory (RAM); non-volatile (NV) memory 220 such as a solid state drive (SSD) or Read Only Memory (ROM); one or more storage devices 230 such as magnetic tape or disc drives; one or more processors 240; an input/output (I/O) interface 250; a communications interface 260; and a system clock 270. The components of computing device may be interconnected using a systems bus 280. Instructions, for example computer software, i.e. computer program code, for operating the computing device 200 in accordance with any of the functionalities described herein may be stored in any of the volatile memory 210, the NV memory 220 and the one or more storage devices 230.

The computing device 200 may comprise further components not illustrated in FIG. 2 and certain components shown in FIG. 2 may be omitted in particular implementations. For example, if the client device 102 is a mobile device the storage device 230 may be omitted, the I/O interface 250 may comprise a touchscreen and/or one or more buttons, and the communications interface 260 may comprise a wireless transceiver. If the client device is a computer terminal, the I/O interface 250 may be connected to any of the following: at least one input device such as a user interface (UI) navigation device such as a mouse and/or a keyboard, at least one display device for viewing still and video image content data, a microphone, a video camera and/or audio speakers. The communications interface 260 may comprise an Ethernet port, for connecting to a network such as the Internet. For a server, there may be multiple processors 240 and backup components.

The client device 102 may comprise, amongst others, cell phones (including so-called “smart phones”), personal digital assistants, tablet and laptop computers, personal computers, game consoles, set-top boxes including any computing device for coupling to a television, televisions connectable to a network with processing capabilities (so-called “smart TVs”).

In the embodiment of FIG. 1, the client devices 102 are capable of being coupled to a network or series of networks such as the Internet 106. The client device 102 may comprise integrated or externally-coupled, e.g. via an additional USB or proprietary device, wired and/or wireless local area network (LAN) capabilities. For example, the client device 102 may be capable of being coupled to a wired and/or wireless router that is in turn connected to a digital subscriber line (DSL), cable or fibre connection to a local exchange; the local exchange being coupled to the so-called Internet using one or more intermediate networks, such as those forming part of the public switched telephony network (PSTN).

If the client device 102 comprises a mobile device such as a smart phone it may have an integrated telecommunications module for wirelessly communicating with a core network coupled to one or more transmission control protocol/internet protocol (TCP/IP) networks; likewise, if the client device 102 comprises a laptop or tablet computer it may have an externally-coupled telecommunications modem (so-called “dongles”, typically coupled via USB) for wireless communication with the core network and the wider Internet. In FIG. 1, the Internet is represented as element 106 but in practice any communications medium or media may be used.

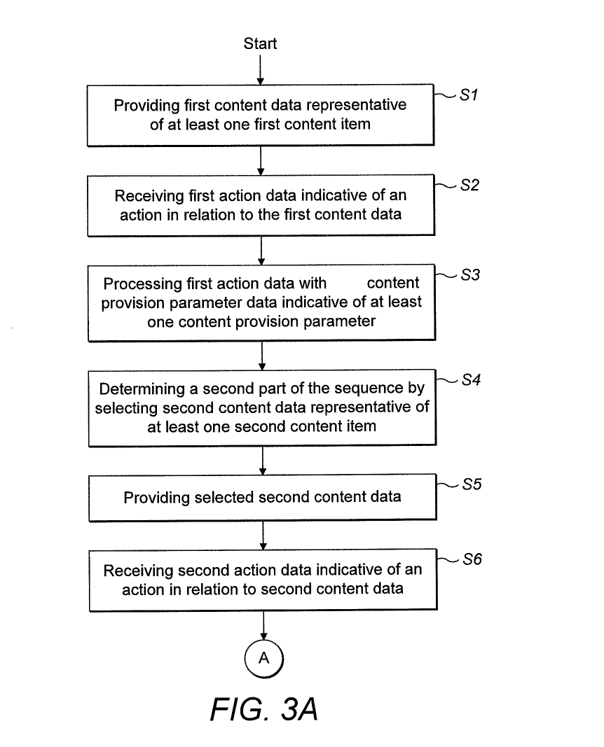

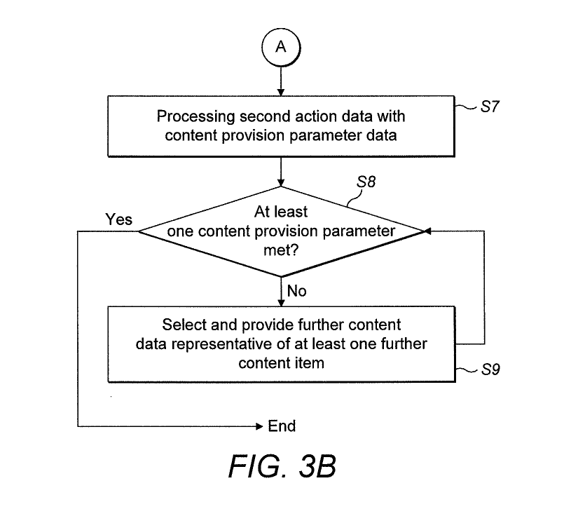

In accordance with embodiments, an overview of a computer implemented method of controlling provision of content data to a computing device, for example one of the client devices 102, will now be described with reference to FIGS. 3A and 3B.

Content data described herein is representative of at least one content item. A content item may be an item of media, for example text such as a question selected from a bank of data indicative of a plurality of questions, an image such as a photograph or a graphic in the joint photographic experts group (JPEG) format, a video for example an animation or audio-video such as a movie in a moving pictures expert group (MPEG) format, audio such as music or recorded speech in an MPEG-1 or MPEG-2 Audio Layer III (MP3) format, a network-distributed program, an applet for example an Adobe® Flash applet, a uniform resource locator (URL), a simulation, at least part of an electronic book, reference and/or help materials, a searching field, a game, access to a downloadable file such as reference material, or a communications tool program providing for example audio-visual video conferencing, text based, and/or social networking type communications with another computing device for a user such as a tutor. Further, the content data may be representative of a content item for modifying a content item previously provided to a computing device. Examples of such a modification include an image modification filter, watermark data and data indicative of a user detail, such as a name, for modifying an image of a user or a graphic of for example an attainment award. The content data may be representative of a subject or topic of content to be provided to a user, for example educational content.

It is to be noted that where selecting and/or providing of a content item is described herein, it is to be understood that data representative of that content item is selected and/or provided.

The content data is provided according to a sequence configured in accordance with content provision parameter data indicative of at least one content provision parameter. A content provision parameter described herein is used to control provision of content data in accordance with a desired content provision objective. The sequence is determined in accordance with action data indicative of an action at the computing device, for example the client device 102, in relation to content data provided during the sequence. Thus, the sequence may for example be determined in dependence on actions in relation to content data which are particular to a given user of the client device 102.

A user of the client device 102 may access the platform 104 using a webpage browser application provided for example by executing instructions stored on the storage device 230. A user interacts with the webpage browser using the graphical user interface (GUI) of the webpage browser application and for example the keyboard and/or mouse of the computing device.

The client device 102 communicates with the authorisation server 118 which is configured to receive requests to access the platform 104. In this instance the client device 102 requests access to a client site provided by the client site server 114, although in other examples access may be requested to the administration server 112. Upon receiving such a request, the authorisation server 118 accesses authorisation data stored in the first database DB1. The authorisation data may include records of users and their permissions for accessing services and data provided by the platform 104, and may include also a subscription status of the user, for example if they have paid a subscription fee to use the platform. The request may include a username and password of a user of the computing device 102, which the authorisation server 118 compares against the records held in the first database DB1. Assuming the request matches records held in the authorisation database, a session is established with the client device 102. In this context, “session” refers to a series of communications between two or more devices, which may be encrypted or unencrypted and which may be identified using a session identifier. Within a session it is assumed that the client device 102 is being operated by an authenticated user. In this case, as the request relates to accessing a client site provided by the client site server 114, the session is established between the computing device 102 and the client site server 114.

The client site server 114 and administration server 112 may provide the client device 102 with access to website data for interaction with by a user. The data for rendering the website may be stored on a storage device of the client site server 114, for rendering by the webpage application browser software of the computing device 102. Such website data may for example be hyper text mark-up language (HTML) data, Javascript data, Cascading style sheet (CSS) data, Adobe Flash data, image data, Javascript Notation Object (JSON) data, and/or Extensible mark up (XML) data.

Data indicative of a user profile is in this example stored in a user profile database, which is the second database DB2. The user profile database may store data records indicative of details of a user, for example name, contact details, age, ethnicity, qualifications, skills and user preferences. The data records may also include preferences set by an administrator user to determine content data to be provided to the user; the role of an administrator user will be described later. The data records may be modified by a user directly, or in accordance with an action, for example an input using the mouse and/or keyboard, performed by the user at the client device in relation to content data provided during the sequence.

Content data representative of a plurality of content items available for providing during the sequence is stored in a content data database, which in this example is the third database DB3. The content data may comprise data indicating at what part(s) in a sequence particular content data items are or are not available for providing to the client device.

As will be explained below, content data representative of at least one content item is selected for provision to the computing device 102, referred to also in examples as the client device 102, via the communications network 106, for use by the computing device, for example providing to a user of a computing device using for example the display device and/or audio speakers. Predetermined rules may specify which content data is to be selected in dependence on an assessed progress of the sequence in relation to the content provision parameter. Therefore, the selection of content data to be provided next in the sequence may operate in accordance with a finite state machine, the next content data to be selected being selected, as determined by the rules, in accordance with an assessed current state of the computing device 102. The assessed progress may be determined using an assessed state of the client device, as will be described later. Data indicative of the rules may be stored in a rules database, in this example the fourth database DB4, which is accessed to determine the sequence and the content data to provide to the client device.

The website data and/or user profile data may be configured to select content data for providing to the client device 102 in accordance with data indicative of at least one content provision parameter which may have been predetermined by an administrator user. Further, the administrator user may have selected content data to be available for provision to the client device during a sequence of providing content data to the client device. Data indicative of the at least one content provision parameter may be stored in the website data and/or the user profile data.

Referring to FIG. 3A, step S1 of the method S1 comprises providing first content data representative of at least one first content item to the computing device, for example the client device 102, in accordance with a first part of the sequence.

Step S2 comprises receiving first action data indicative of an action at the computing device in relation to the first content data.

Step S3 comprises processing said first action data with the content provision parameter data to assess a state of the computing device in relation to the at least one content provision parameter.

Step S4 comprises determining a second part of the sequence using data indicative of the assessed state of the computing device by selecting second content data representative of at least one second content item.

Step S5 comprises providing the selected second content data to the computing device, in accordance with the second part of the sequence.

Step S6 comprises receiving second action data indicative of an action at the computing device in relation to the second content data.

Referring now to FIG. 3B, which continues from FIG. 3A, as indicated by label A, step S7 comprises processing the second action data with the content provision parameter data to assess further a state of the computing device in relation to the at least one content provision parameter.

Step S8 comprises determining at least one further part of the sequence, such as a third part, using data indicative of the further assessed state of the computing device by determining whether or not the at least one content provision parameter is met.

If the content provision parameter is met, the method ends.

If the content provision parameter is not met, further content data representative of at least one further content item is selected and provided to the computing device in step S9.

If after a third part of the sequence it is determined again at step S8 that the at least one content provision parameter is still not met, steps S9 and S8 repeat until the at least one content provision parameter is met, thus ending the sequence. In this way, further parts of the sequence may be determined, for example a fourth part and a fifth part.

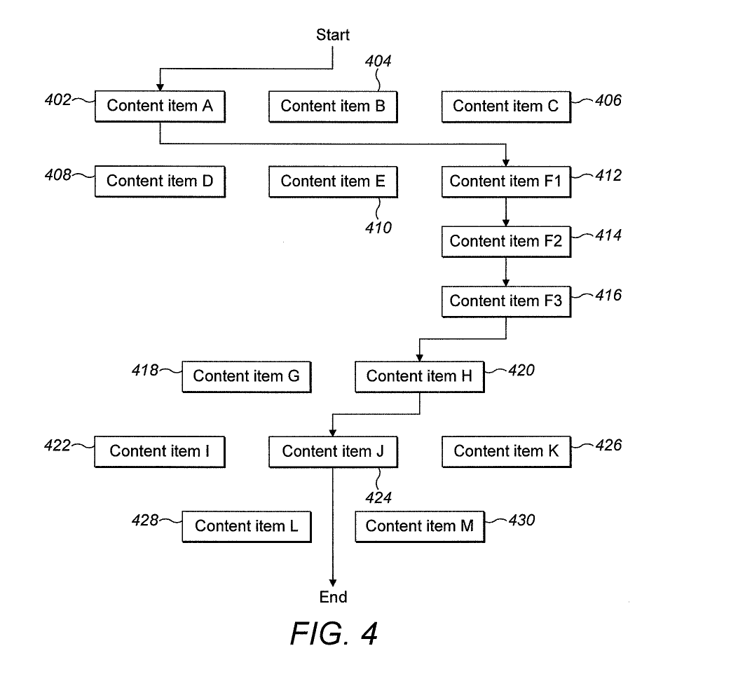

A detailed example of the method of controlling provision of content data described using FIGS. 3A and 3B will now be described, referring to FIG. 4 and the system described using FIG. 1.

Before starting the method, a computing device 102 may connect to the platform 104 via the network 106, as described above.

In this example, the data indicative of the content provision parameter comprises data indicative of a target duration of the sequence, in this example 20 minutes; in other words, it is desired that the sequence runs for 20 minutes, although alternative target durations are envisaged. In this example, the content data to be provided relates to an education course for a user of the client device 102 having a target duration. The method allows content data to be selected and provided in keeping with this duration.

In examples to be described, content data representative of at least one content item may be selected from content data representative of a plurality of content items. In other examples, selecting content data may comprise selecting content data representative of a content item for modifying a content item represented by content data previously provided to the client device 102, as described above.

As the first part of the sequence, which corresponds with step S1 of FIG. 3A, the computing device 102 is provided with first content data representative of at least one first content item, in this example content item A 402 shown in FIG. 4.

In this example the first content data is selected from data representative of three available content items, namely content item A 402, content item B 404 and content item C 406. The first content item may be selected in accordance with data indicative of a user profile detail for example an age group; for example the first content item may comprise introductory text or an introductory video to the education course, with each of content items A, B and C being written in a different style for different age groups of users. Therefore, if content item A is written for the age group 18 to 30, content item B is written for the age group 31 to 40 and content item C is written for the age group 41 and over, and the user profile data indicates a user age of 21, content item A is selected and provided to the computing device over the communications network 106, for viewing by the user on the display device.

It is to be appreciated that in other examples a different first content item may be provided than described. For example, a common first content item may be provided at the start of each sequence, regardless of user profile data.

Corresponding with step S2 of FIG. 3A, the client site server receives first action data indicative of an action at the computing device in relation to the first content data. In this example the first action data may be indicative of a duration in relation to the computing device 102 using the first content data, for example a duration of the computing device displaying the first content item. The first action data may be generated by the computing device and transmitted to the client site server. The first action data may be indicative of an action including at least one input to the computing device, for example a user using the mouse in conjunction with the GUI to select a button confirming the first content item has been viewed and understood by the user. In this example, the first action data indicates a duration of the computing device 102 using, in this case displaying, the at least one first content item until the at least one input is received. Alternatively, the action indicated by the first action data may be a time-out action where, if after a predetermined period of time no input has been received at the computing device 102, in response to displaying the at least one first content item for example, the computing device generates first action data indicative that no input has been received.

Corresponding with step S3 of FIG. 3A, the first action data is processed with the content provision parameter data indicative in this example of the target duration. In this way a state of the computing device 102 in relation to the at least one content provision parameter may be assessed; in other words, the state of the computing device. This assessed state may be a measure of progress through the sequence in respect of the target duration by indicating the state after using the first content item. Such a state may be a state indicative of having used the first content item for a certain duration and now waiting to receive further content data from the client site server. The processing of step S3 may for example include comparing the first action data indicating the duration of the computing device having used the first content item, with the target duration, to calculate an elapsed time of the target duration and therefore the remaining time for the sequence.

Corresponding with step S4 of FIG. 3A, second content data representative of at least one second content item is selected in accordance with the assessed state. This determines the second part of the sequence. In this example, the second content data is selected in accordance with a predicted duration for the client device 102 using the second content data. In this example, the second content data is selected from content data representative of a plurality of content items, each of the plurality of content items being associated with a predicted duration for being used by the computing device; the selecting comprises: a) comparing data indicative of the predicted duration for each one of the plurality of content items with data indicative of a remaining duration of the sequence; b) identifying at least one of the plurality of content items having a predicted duration less than or equal to the remaining duration; and c) selecting the identified at least one content item as the at least one second content item. This selecting may involve comparing against the remaining duration the predicted duration only for each of a plurality of content items marked in the content item database as being available immediately next in the sequence, or comparing against the remaining duration the combined predicted durations of different combinations of content items if they were to be provided consecutively during the sequence.

In this example, the available content items for the second part of the sequence are content item D 408, content item E 410 and content items F1 412, F2 414 and F3 416. It is noted that although content items F1, F2 and F3 are three separate content items, they are grouped together for providing as consecutive content items during the second part of the sequence.

To give an example, if the first action data indicates a duration of the computing device using, for example displaying, the at least one first content item for 1 minute until the at least one input was received, it is calculated that 19 minutes remain of the target duration of 20 minutes. If content item D is associated with a predicted duration of 5 minutes, content item E is associated with a predicted duration of 10 minutes and content items F1, F2 and F3 are associated with a combined predicted duration of 15 minutes, then the rules may specify that content items F1, F2 and F3, with the longest predicted duration, are to be selected as the at least one second content item, given there would still be time available to complete any subsequent parts of the sequence.

Consequently, and corresponding with step S5, the selected second content data is provided to the computing device 102, in accordance with the second part of the sequence, in this example by transmission to the computing device 102.

In a similar way as described above for the first content data, and corresponding with step S6 of FIG. 3A, the computing device 102 may generate second action data indicative of an action at the computing device 102 in relation to the content data representative of the second content item. The second action data is transmitted by the computing device and received by the client site server and in this example is indicative of a duration in relation to the computing device 102 using the second content data, for example displaying the at least one second content item for the user. The second action data may be, and in this example is, indicative of an action including at least one input to the computing device, for example a user selecting a button using the mouse and the GUI to confirm the at least one second content item has been viewed and understood by the user. Alternatively, the second data may be indicative of a time-out action, in a similar manner as described previously.

In accordance with step S4 of FIG. 3B, the second action data is processed with the content provision parameter data to assess further the state of the computing device in relation to the at least one content provision parameter, in this example the target duration. Thus, a progress through the sequence may be measured. In this example, similar as described above for the first action data, the processing may include comparing the second action data indicating the duration that the computing device has used the second content data, added to the duration of using the first content data, with the target duration, to calculate an elapsed time of the target duration and therefore the remaining duration of the sequence. It should be noted that an actual duration of use of the second content data may not match the predicted duration, as this depends on a user's interaction; however, the sequence may be determined accordingly, using the second action data, to provide further content item data to meet the target duration content provision parameter.

Corresponding with step S8, it is determined whether the at least one content provision parameter is complete, in this case whether the target duration for the sequence has expired.

If in this example the at least one second content item was used by the computing device until the at least one input for a duration of 6 minutes, then the elapsed duration of the sequence is 7 minutes, this being the sum of the 1 minute duration in relation to the first content data and the 6 minutes in relation to the second content data. Therefore, the remaining duration for the sequence is the difference of 7 minutes and the target duration of 20 minutes, namely 13 minutes. It is envisaged that time during the sequence may be occupied by data transmission and processing delays. The client site server may be configured to monitor any such delays and account for them when processing to calculate the elapsed and remaining duration of the sequence, and determine the sequence accordingly.

The next available content items in the sequence are content item G 418 and content item H 420. In this example, similar as for the second content data, each of the content items G and H are associated with a predicted duration, in this example 5 and 10 minutes, respectively. On this basis it is determined that further content data representative of at least one further content item may be selected and provided to the computing device 102, in accordance with step S8, rather than ending the sequence.

The further content data is selected in accordance with a predicted duration for the computing device using the further content data. In this example, the further content data is selected from data representative of a further plurality of content items each being associated with a predicted duration for being used by the computing device; the selecting comprises: d) comparing data indicative of the predicted duration for each one of the further plurality of content items with data indicative of a remaining duration of the sequence; e) identifying at least one of the further plurality of content items having a predicted duration less than or equal to the remaining duration; and selecting the identified at least one of the further plurality of content items as the at least one further content item. As in relation to the at least one second content item, the selecting of the at least one further content item may involve comparing the predicted duration only for each of a plurality of content items available immediately next in the sequence, or comparing the combined predicted durations of different combinations of content items if provided consecutively during the sequence.

In this example, the content data indicates that further content items are available after content items G and H, and therefore the content data representative of content item G, which in this case has the shorter predicted duration, is selected and provided to the computing device.

In a similar manner as described above for the at least one first and second content items, further action data indicative of an action at the computing device in relation to the further content data is generated and transmitted by the computing device and received by the client site server. This further content data may be indicative of a duration that the computing device uses, for example displays, the at least one further content item until at least one input to the computing device is made. The further content data may be processed with the content provision parameter data, in a similar manner as described above, to assess a state of the computing device in relation to the at least one content provision parameter.

In this example, if the duration that the computing device displays content item G until at least one input is 5 minutes, then it may be calculated that the remaining duration for the sequence is 8 minutes. The next available content items are content item I 422, content item J 424 and content item K426, having associated predicted durations of 10, 8 and 12 minutes, respectively. Therefore, given the remaining duration of the target duration, content item J 424 may be selected and provided to the computing device in a similar manner as described for the at least one first and second content items.

Finally, further action data generated by the computing device may indicate an action in relation to the content item J. For example, a duration of being used by the computing device before at least one input may be 7 minutes. On this basis, it is calculated that the remaining duration of the target duration is 1 minute. However, although content items L 428 and M 430 are available next in the sequence, with associated predicted durations of 5 and 6 minutes, for example, it is determined that selecting and providing either of the content items L or M will exceed the target duration. Therefore the sequence ends in order to meet the content provision parameter.

It will be appreciated that as the sequence is determined as the method progresses, and depends on a duration for which each content data item is used by the computing device, alternative sequences may be determined in which different of the content items shown in FIG. 4 are provided, where content items are used for different durations, compared with the example given above.

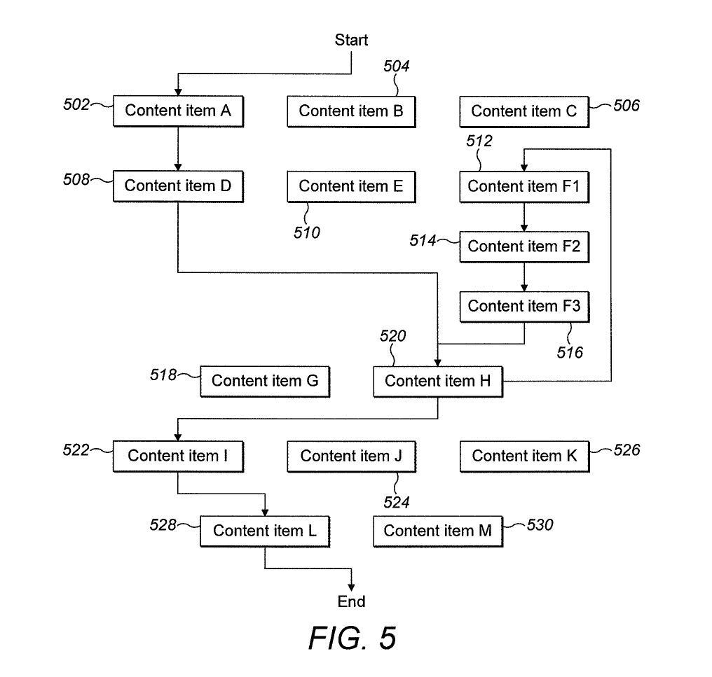

An alternative example will now be described, referring to FIG. 5, of the method described above using FIGS. 3A and 3B. For convenience, the content items illustrated in FIG. 5 use the same notation as those described in FIG. 4, except the reference labels are incremented by 500 rather than 400.

First, a user of the computing device 102 connects to the platform, as described for example previously.

In this example the data indicative of a content provision parameter comprises data indicative of a target data value of a measurement parameter to be met during the sequence. In this example, the content data to be provided relates to a test for a user of the computing device 102, to measure knowledge of a topic. The sequence can be determined in dependence on their knowledge, as measured during the sequence, so as to efficiently provide relevant content data to the user. The measurement parameter may indicate a performance measure such as a score that a user gains, based on their interaction with content items provided via the computing device. In other examples, the measurement parameter may also, or alternatively, denote that a user has been provided with a required number of content items of different classifications; for example, such classifications may relate to education topics.

As the first part of the sequence, corresponding with step S1 of FIG. 3A, the computing device 102 is provided with data representative of at least one first content item.

In this example the first content item is selected from three available content items, namely content item A 502, content item B 504 and content item C 506 which each provide text of a first question as part of the test. As for the example of FIG. 4, the at least one first content item may be selected in accordance with data indicative of a user profile detail. In this example the first content item is selected on the basis of a level of qualification the user has. The level of qualification may have been determined by a previous assessment. For example, content item A may be for a basic level user, content item B may be for an intermediate level user and content item C may be for an advanced user. In this case, the user profile data indicates a basic level of qualification, and therefore content item A is selected and provided to the computing device 102 as the first content item.

It is to be appreciated that in other examples a common first content item may instead be provided in the first part of the sequence. For example, the at least one first content item may include text of a first test question, to initially assess the level of qualification of the user, so as to select content data relating to an appropriate level of qualification during the rest of the sequence.

Corresponding with step S2, the client site server receives first action data, generated and transmitted by the computing device which is indicative of an action in relation to the at least one first content item. Such an action may for example be an input made using the GUI, keyboard and/or the mouse in order to provide an answer to the test question given by the at least one first content item. The input may involve a user selecting which of a list of answers they consider is correct, or typing an answer.

In this example the first action data is indicative of a first measurement data value of the measurement parameter. The action indicated by the first action data indicates at least one input to the computing device, and the first measurement data value is determined in accordance with a measurement of the at least one input.

The first measurement data value may for example be determined by the client site server, but alternatively may be determined by the client device 102, based on a comparison of the first action data with measurement data associated with the at least one first content item. This measurement data indicates measurement data values which may be assigned to the action in relation to the at least one first content item. For example, a measurement data value that can be assigned to the action is 2, 1 or 0; if the action data indicates an answer given to the question is correct, then a measurement data value of 2 is assigned, if the answer is partially correct a measurement data value of 1 is assigned, and if incorrect a measurement data value of 0 is assigned. It is to be appreciated that alternative measurement data values may be assigned to the action in other examples. By assigning a measurement data value in this way the at least one input, i.e. action, may be measured. It is noted that if an action indicated by the first action data includes a time-out action, the first measurement data value may be determined in accordance with a measurement assigned to a time-out action; i.e. the measurement data may include a measurement data value to be assigned in the event of a time-out action, for example a value of 0. The measurement data may be stored in the content data database DB3.

Corresponding with step S3, in this example the client site server processes the first action data with the content provision parameter, to assess the state of the computing device in relation to the at least one content provision parameter. The state of the computing device may be considered to be the state at the point in the sequence that the computing device is currently at, after the action in relation to the first content data.

The state of the computing device 102 may be assessed by comparing the assigned measurement data value with the target data value of the measurement parameter for the sequence. Thus, the assessed state in this example is used to indicate how close to meeting the content provision parameter the computing device is.

In this example, on the basis of data indicative of the assessed state of the computing device, and therefore of the assigned measurement value, the predetermined rules specify that for an assigned measurement value of 2, content data representative of content item D 508 is selected, in accordance with step S4, as the at least one second content item; this determines the second part of the sequence.

If in this example a measurement data value of 1 or 0 had been assigned instead, then, in accordance with the rules in this example, content item E 510 or F1 512, F2 514 and F3 516, respectively, would have been selected as the at least one second content item. The rules may be configured, in dependence on the assessed state of the computing device, to select one of the next available content items D, E or F on the basis of the content item offering the highest available measurement data value for the second part of the sequence; for example, each content item may be associated with data stored in the content data database DB3 indicating the maximum available measurement data value for that content item. Thus, if a low value was obtained in response to the at least one first content item, the rules may be set to select the at least one second content item having the highest available measurement data value of the available content items, to give the opportunity to compensate for the previous low value by improving an aggregate measurement data value over the first and second content items. Alternatively, each content item may be associated with a level of difficulty rating; if a low measurement data value was assigned in response to the at least one first content item, the rules may be set to select the content item with the easiest difficulty rating as the at least one second content item, as the first content item may have had too high a difficulty rating for the user.

Corresponding with step S5, in this example the data representative of the content item D 508 is provided to the computing device.

In accordance with step S6, the client site server receives second action data indicative of an action in relation to the at least one second content item. The action may be similar to that described in relation to the at least one first content item, except being in relation to the at least one second content item. Thus, the second action data is indicative of a second measurement data value of the measurement parameter, which may be assigned to the action in relation to the second content item, in a similar manner as described above for the first measurement data value.

Corresponding with step S7, the second action data is processed with the data Indicative of the content provision parameter, namely the target data value of the measurement parameter for the sequence, to assess further the state of the computing device in relation to the at least one content provision parameter. In particular, in this example, the aggregate of the first and second measurement data values is compared with the target data value of the measurement parameter, to further assess the state of the computing device and therefore the progress in meeting the content provision parameter.

Using data indicative of the further assessed state, at least one further part of the sequence is determined in accordance with step S8 by determining whether the at least one content provision parameter is met and therefore whether or not data representative of at least one further content item is to be selected and provided to the computing device in accordance with step S9. For example, if a total of the first and second measurement data values meets the target data value of the measurement parameter, it is determined that the content provision parameter is met. However, if the total of the first and second measurement data values does not meet the target data value, it is determined to select and provide at least one further content item, as per step S9, in order to meet the content provision parameter.

As illustrated in FIG. 5, the sequence configured in this example provides several further content items, namely content item H 520, content items F1 512, F2 514 and F3 516, content item I 522 and content item L 528. It is noted that after content item H content items F1, F2 and F3 are provided, although these were available for an earlier part of the sequence. This may occur for example if a measurement data value assigned to at least one input in relation to content item H is low; content items F1, F2 and F3 may provide additional information to a user of the computing device, with the aim of remedying the reason for a low measurement value. After F3, content item H is provided again, and, as content item I is selected thereafter, in this example the measurement data value assigned to the action in relation to content item H was higher the second time it was provided. Therefore, in this example, content item H may provide content data indicative of at least one question to test a user, whereas content items F1, F2 an F3 may provide content data indicative of information for a user to learn. Thus, the different content items may serve a different purpose in the sequence.

In another example of an embodiment of a method according to the overview given using FIGS. 3A and 3B, the content provision parameter data comprises data indicative of a target resource transaction process, for example a purchase transaction, to be performed at least partly by the computing device. The resource transaction process may involve steps of the computing device 102 receiving data input by a user which is indicative of initiating a resource transaction process, and the client device communicating with the client side server to initiate the resource transaction process. The client device 102 may then confirm to the user when the resource transaction process is complete. If after the first part of the sequence the target resource transaction process is not initiated or complete, the second content data may be selected to assist the target resource transaction process to occur. Further, if the second action data indicates the target resource transaction process has not occurred, the further content data may be selected to assist the target resource transaction process to occur. For example, the second content data and/or the further content data may be representative of text or image content items, for example for a website, which explain and/or illustrate instructions or suggestions for initiating the target resource transaction process.

It will be appreciated that many other examples of content provision parameters than those described above may be used to configure a sequence in accordance with further embodiments. For example, data indicative of a geographical location of the computing device may be used to select content data for providing to the computing device. Further, it will be appreciated that many examples of actions in relation to the computing device using content data, to assess a state of the computing device for use in determining a part of the sequence, are envisaged. For example action data may indicate a measure of how long a user has viewed a video content item for compared with the maximum video content duration, or may be indicative of an input to select one of a plurality of options provided to a user. It is to be appreciated that data required to provide the functionality of any of these examples may be stored by the database server.

Examples described above relate to determining a sequence in accordance with one content provision parameter. It is envisaged in further examples that a sequence may be determined in accordance with two or more content provision parameters. For example, in one embodiment, a sequence may be determined in accordance with the content provision parameters of the target duration of the sequence and the target data value of the measurement parameter described above; in such an example, the rules may be predetermined to select second content data on the basis of a combination of the duration the computing device 102 uses the first content data and an assigned data value of the measurement parameter in relation to the first content data. This applies similarly for selecting and providing at least one further content item. In such an example, a predetermined rule may specify that if a duration of using the first content data and an assigned data value of the measurement parameter are greater than predetermined values set in the rule, particular content data is selected for providing as the second part of the sequence. In contrast, if the duration and assigned data value are less than the predetermined values set in the rule, then the rule specifies to select alternative content data to provide as the second part of the sequence. An example of using such combined content provision parameters is where an education course aims for a user to attain a predetermined score in a test having a set duration.

In further embodiments, the data indicative of a previously determined sequence in relation to controlling provision of content data to a computing device, in accordance with the at least one content provision parameter, is used in at least one of the selecting of the first content data, the selecting of the second content data and the selecting of the further content data. Data indicative of at least one previously determined sequence may be stored in a log database, in this example the fifth database DB5, and may be used in determining a new sequence. For example, in the case described above where the content data provision parameter is a target duration, a content item may be selected for provision to the computing device on the basis of an associated predicted duration which is less than other content items which may be selected. However, using the data indicative of at least one previously determined sequence, a content item having a greater predicted duration may be selected instead, on the basis that from previously determined sequences the total duration of the sequence was for example less on average than the total duration of a sequence if the content item having a predicted duration less than the other content items had been selected. In an example, the data indicative of a previously performed sequence indicates a probability of meeting the content provision parameter if at least one of the first content data, the second content data and/or the further content data was to be selected. For example, from previously determined sequence data, the probabilities may indicate that 30% of users provided with a particular content item as the next part of the sequence meet the content provision parameter, whereas 70% of users provided with a different content item as the next part of the sequence meet the content provision parameter. The probabilities may be provided as data indicative of weightings for influencing configuration of the sequence. The rules may be configured to use such probability data in configuring the sequence.

In further examples, the data indicative of a previously performed sequence may be used in combination with user profile data; for example, a content item may be selected in preference over another if the data indicative of a previously performed sequence indicates that a content data provision parameter is more likely to be met by selecting a particular content item to provide to the computing device if the user meets a predetermined user profile criteria such as a certain age group.

The content data described above is representative of at least one content item. Therefore, one or more content items may be selected and provided together, simultaneously. For example, at least one of the first content data, the second content data and/or the further content data is representative of a group of content items to be used together by the computing device.

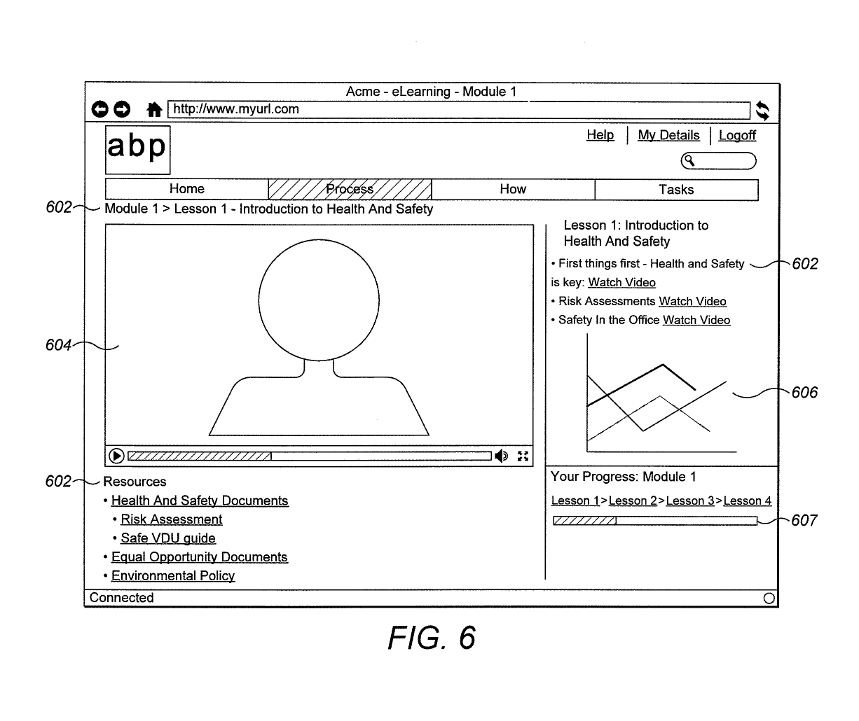

FIG. 6 illustrates an example of a group of content items which may be displayed together simultaneously by the display device of the computing device 102, as a webpage. As can be seen, text content items 602 may be provided which may include URL data so a user can access further content items such as resource materials or videos. A video content item 604 is provided; in this example this is video data for introducing a health and safety educational course. Graphics are also provided to provide for example a graph 606 and a progress bar 607 indicating progress in the course. It is envisaged that an action in relation to one content item may trigger an action in another content item; for example an action in relation to a text content item 602, for example an input indicative of a user acknowledging understanding the text, may trigger the video content item 604 to start displaying video content.

In other examples, at least one of the first content data, the second content data and the further content data is representative of a series of content items to be provided to the computing device. Thus, a plurality of selected content items may be provided to a user consecutively, each content item relating to for example a different sub-topic, the content items together, in series, relating to a single topic. At least one selected and provided content item provided in series is illustrated by content items F1, F2 and F3 in FIG. 5.

In examples, data indicative of at least one preference for providing content data to the computing device is used in at least one of providing first content data, second content data and further content data. The data indicative of at least one preference for providing content data to the computing device may be at least partly generated on the basis of an action at the computing device in relation to provision of the at least one first content item, the at least one second content item and/or the at least one further content item. For example, in the case where the content data provision parameter is a target data value of a measurement parameter, the performance of a user interacting with provided content data may be analysed. From this analysis it may be identified that a particular user obtains a higher measurement data value in relation to image content items than textual content items. Data indicative of a user profile for that user may be updated to indicate a preference for selecting image content items over textual content items for providing to the user. Thus, the sequence of content data provided may be determined based on the abilities of a user, meaning content data is selected which is more appropriate to those abilities. In other examples, it may identified that a user for example has a preference to interact with content items of a particular style, for example a colour or design scheme. The user profile data may be updated to reflect this, so that content items selected and provided later in the sequence are more in keeping with this preference.

Additionally, or alternatively, the data indicative of at least one preference for providing content data to the computing device may be at least partly generated before commencing the sequence. For example, a user may provide input data indicative of user preferences before a sequence started. For example, a user may have a preference for image type content items, or may prefer not to be provided with audio-visual content items for example if a connection between the computing device 102 and the platform 104 is inadequate for streaming audio-visual content. A further example of a preference relates to specifying a type of computing device to which the content data is provided; for example, if a mobile telephone is specified, with the content data provided over a wireless telecommunications network, data indicative of at least one content item to be provided during the sequence may be selected with a lower data size, or compressed data may be selected which is representative of a lower quality version of at least one content item, compared with content data representative of at least one content item for providing over a communications network with a greater available rate of data transfer. The type of computing device may be specified by a user, or may be indicated by data transmitted by the computing device, and the data indicative of at least one preference for providing content data updated accordingly, so that content data suitable for that device is provided during the sequence. Data indicative of a user preference, whether provided before the start of the sequence, or generated during the sequence, may be stored in the user profile database DB2. The user profile database DB2 may be accessed by the client site server to assist determining of the sequence.

In accordance with embodiments, further functionality of the system will now be described.

As explained above, the client site server provides content data to a computing device 102. A user may also provide and modify data indicative of a user profile, stored in the user profile database DB2. Further, the client site server may monitor and analyse the determination of a sequence of providing content data for particular users. Analytical data may be generated which indicates a performance and/or a behaviour of one or more users in relation to the content data provision parameter and/or to any content data provided. Such analytical data may be stored in an analytics database, for example the sixth database DB6. For example, analytical data for one user may indicate a total measurement data value obtained during a sequence according to the example described using FIG. 5; this value may indicate a test result of a user. Many other examples of analytical data may be generated; for example a duration of a sequence of providing content data for use by a computing device 102, a record of each content item provided to the computing device 102, a preference of a user for a particular colour or design style of content data which might influence their actions for example in relation to initiating a target resource transaction process, and/or a record of any input to the computing device by a user may be recorded including for example an input expressing a preference for one content item over another content item. Moreover, a user may use the computing device to generate data indicative of feedback in relation to the sequence of content item data; such feedback data may also be stored as analytical data. In an example, a user may assign data indicative of a rating to the data indicative of that content item. This assigned rating data may for example be used to assist selection of content data for providing during a sequence; for example, if one content item is rated more highly than another, the more highly rated content item may be selected for providing during a sequence instead of a less highly rated content item.

Analytical data may be generated which indicates the performance and/or a behaviour of a group of users. Such a group may be for example a class of users for which the same content data provision parameter applies for a sequence determined for each user of the class. Analytical data such as those examples given above may be generated for such a group or groups of users, to identify trends of users of the class in relation to their performance and/or behaviour in relation to content data provided. For example the analytical data may give an average total measurement data value calculated for the group, a statistical segmentation of measurement data values calculated for the group such as a deviation from a mean measurement data value for the group, an average total duration of the sequence for the group or data indicative of users associated with a total measurement data value within the lowest 10% of total measurement data values obtained for the whole group. Numerous further examples are envisaged. In another example, two different groups of users may be provided with two different sets of content items which are available in a sequence; the effect this has on the sequences determined for the users of the different groups may be analysed, to assess which set of content items is more effective for a content provision parameter to be met; this may be useful for an administrator to test the effectiveness of an educational course or a website they create which provides content data according to a method described herein.

A user such as a student of an education course described above may access the analytical data. An administrator user may also access the analytical data as explained further below.

The function of the administration server 112 and the role of an administrator user will now be described. There may be different types of administrator user which are defined in the user profiles database DB2. An administrator user may access the administration server by connecting via a session between a client device 102 and the administration server 112, in a similar manner as described above.

An example of a first type of administrator is a creator of a programme, such as an education course, for providing content data in accordance with a sequence as described herein. This administrator may be a tutor, for example. For this purpose, the administration server provides the administrator with a creation tool application allowing them to design the programme via a GUI and the mouse and/or keyboard for example. This may involve selecting content data which is to be available during a sequence to be determined during operation of the programme. Content data may also be provided from an external source, for example via an API of a source and/or system outside the content provision platform. Relationships between the available content data may also be set, for example in accordance with a hierarchy determining at what stage during a sequence certain content data will become available, and which content data may be provided next in a sequence after other content data. In creating the programme, the creator administrator also sets the rules which determine how the sequence will be configured when the programme is run. Thus, a finite state machine for operating a sequence may be determined. The rules may be written using an API, for example to translate natural language input into the correct rule syntax required by the platform. The rules can be set to use data stored in any of the databases described to set how a sequence will be determined, for example user profile data such as a user age and/or user preferences, content data, and/or data indicative of a previously performed sequence. For example, a rule may be set that if a user has an age below 18 then certain content data is provided next in a sequence, but if the user is 18 or older different content data is provided next in the sequence.

The programme administrator may also define at least one content provision parameter for the programme, according to which the rules will be set. In the example where the content provision parameter is a target data value of a measurement parameter, as explained above, a rule may be set such that if a total, i.e. aggregate, data value of the measurement parameter over the sequence so far is greater than 50, then certain content data is provided next in a sequence, but if the total is less than 50 than alternative content data is to be provided next. As explained above, a sequence may be determined in accordance with more than one content provision parameter. The rules would be set accordingly. Further, a rule may determine that user profile data may be for example updated based on progression through the sequence. For example, user profile data may be updated to reflect an attainment of an intermediate qualification level based on performance in relation to content data provided. Data indicative of a programme created by the administrator, for example a hierarchy of different content items for a sequence, and/or data indicative of a layout for providing multiple content items together, may be stored in a programme database, such as the seventh database DB7. Rules data may be stored there also, or in the rules database DB4 described previously. This may be accessed by the client site server when providing the programme to a user such as a student undergoing the programme. The administration server may also allow a created programme to be tested; for example, two or more different trial programmes may be created, for testing. Each trial programme may be a partially complete programme, to demonstrate the functionality of the programme. In such a trial programme, place holders may be used to indicate on a GUI where content items would be located. This allows trial programmes to be demonstrated, and one selected for completion, without needing to complete each trial programme first. Each trial programme may be associated with data indicative of programme characteristics, for example data indicative of a cost to complete and/or operate a particular programme if completed, and data indicative of a measure of effectiveness of the programme for its purpose, such as educating a user. Factors such as the type of content item data to be used in the programme may influence such characteristics; for example, where the programme is an educational course, video content data may be more effective at educating a user than textual content data; however, video content data may be more costly to provide, for example by incurring higher license fee costs. Such factors would be indicated by the data indicative of programme characteristics, so a trial programme may be selected, by a programme sponsor for example, for completion. The analytical data to be recorded when a user runs the programme may also be set as part of the programme data. Another type of administrator role is a content administrator. This administrator may access the content data database DB3 to update and/or modify any of the content data and may be a programme administrator described above, or a third party supplier of content data. Content data representative of a content item may include further data associated with it for use in the method of providing content data; for example, data indicative of a predicted duration associated with a content item, and/or data indicative of data values of a measurement parameter which may be assigned in dependence on an action at the client device in relation to the content item, as described previously.

Other types of administrator role are envisaged, including a sponsor or manager administrator and a platform administrator who may have permissions to review analytical data in relation to a programme providing content data according to a sequence. A sponsor and/or manager administrator may sponsor or manage a programme; for example, where the programme is an education course the programme administrator may be a tutor and the manager administrator may be a head of department, or head of education institution, for example. A sponsor may fund a programme, and therefore a sponsor administrator may represent a different organisation than the education organisation.

The above embodiments are to be understood as illustrative examples. Further embodiments are envisaged. For example, in embodiments described above, a method of controlling provision of content data is provided over a computer network; in other examples the method may be provided by a stand-alone computing device, such as that described previously, comprising at least one memory loaded with instructions and data for performing the method. Further, it is to be appreciated that methods described herein are not limited to for example the purpose of providing education content; numerous further applications are envisaged of the method of embodiments described herein. It is to be understood that any feature described in relation to any one embodiment may be used alone, or in combination with other features described, and may also be used in combination with one or more features of any other of the embodiments, or any combination of any other of the embodiments. Furthermore, equivalents and modifications not described above may also be employed without departing from the scope of the accompanying claims.

1. A computer implemented method of controlling provision to a computing device of content data representative of at least one content item, the content data being provided according to a sequence determined in accordance with content provision parameter data indicative of at least one content provision parameter, the sequence being determined in accordance with action data indicative of an action at said computing device in relation to content data provided during the sequence, the method including:
providing first content data representative of at least one first content item to the computing device, in accordance with a first part of said sequence;
receiving first action data indicative of an action at said computing device in relation to said first content data;
processing said first action data with the content provision parameter data to assess a state of said computing device in relation to the at least one content provision parameter;
determining a second part of the sequence, using data indicative of said assessed state of the computing device, by selecting second content data representative of at least one second content item,
providing said selected second content data to the computing device, in accordance with the second part of the sequence;
receiving second action data indicative of an action at said computing device in relation to said second content data;
processing said second action data with the content provision parameter data to assess further a state of said computing device in relation to the at least one content provision parameter; and
determining at least one further part of the sequence, using data indicative of said further assessed state of the computing device, by determining whether the at least one content provision parameter is met or whether to select and provide the computing device with further content data representative of at least one further content item.

2. A computer implemented method according to claim 1, wherein the first content data, the second content data and the third content data are representative of educational content.

3. A computer implemented method according to claim 1, wherein the content provision parameter data comprises data indicative of a target duration of the sequence.

4. A computer implemented method according to claim 3, wherein said first action data is indicative of a duration in relation to the computing device using first content data.

5. A computer implemented method according to claim 4, wherein the action indicated by the first action data includes at least one input to the computing device, the first action data indicating a duration of the computing device using the at least one first content item until said at least one input.

6. A computer implemented method according to claim 4, wherein the action indicated by the first action data includes a time-out action.

7. A computer implemented method according to claim 3, wherein said second content data is selected in accordance with a predicted duration of the computing device using said second content data.

8. A computer implemented method according to claim 7, wherein said second content data is selected from data representative of a plurality of content items, each of said plurality of content items being associated with a predicted duration of being used by the computing device, said selecting comprising:
a) comparing data indicative of the predicted duration for each one of said plurality of content items with data indicative of a remaining duration of the sequence;
b) identifying at least one of the plurality of content items having a predicted duration less than or equal to the remaining duration; and
c) selecting said identified at least one content item as the at least one second content item.

9. A computer implemented method according to claim 3, wherein said further content data representative of the at least one further content item is selected in accordance with a predicted duration of the computing device using said further content data.

10. A computer implemented method according to claim 9, wherein said further content data is selected from data representative of a further plurality of content items, each of said further plurality of content items being associated with a predicted duration of being used by the computing device, said selecting of the further content data comprising:
d) comparing data indicative of the predicted duration for each one of said further plurality of content items with data indicative of a remaining duration of the sequence;
e) identifying at least one of the further plurality of content items having a predicted duration less than or equal to the remaining duration; and
f) selecting said identified at least one of the further plurality of content item as the at least one further content item.

11. A computer implemented method according to claim 1, wherein the content provision parameter data comprises data indicative of a target data value of a measurement parameter to be obtained during the sequence.

12. A computer implemented method according to claim 11, wherein said first action data is indicative of a first measurement data value of the measurement parameter.

13. A computer implemented method according to claim 12, wherein the action indicated by the first action data includes at least one input to the computing device, the first measurement data value being determined in accordance with a measurement of the at least one input.

14. A computer implemented method according to claim 12, wherein the action indicated by the first action data includes a time-out action, the first measurement data value being determined in accordance with a measurement made in relation to the time-out action.

15. A computer implemented method according to claim 12, wherein the second content data is selected in dependence on whether or not the first measurement data value meets the target data value.

16. A computer implemented method according to claim 12, wherein the second action data is indicative of a second measurement data value of the measurement parameter.

17. A computer implemented method according to claim 16, wherein
if a total of the first and second measurement data values meets the target data value, it is determined that the content provision parameter is met; or
if a total of the first and second measurement data values does not meet the target data value, it is determined to select and provide the computing device with said further content data.

18. A computer implemented method according to claim 1, wherein the content provision parameter data comprises data indicative of a target resource transaction process to be performed by the computing device.

19. A computer implemented method according to claim 18, wherein the second content data is selected to assist the target resource transaction process to occur.

20. A computer implemented method according to claim 19, wherein if the second action data indicates the target resource transaction process has not occurred, said further content data is selected to assist the target resource transaction process to occur.

21. A computer implemented method according to claim 1, wherein data indicative of a previously performed sequence in relation to controlling provision of content data to a computing device, in accordance with the at least one content provision parameter, is used in at least one of said selecting of the first content data, said selecting of the second content data and said selecting of the further content.

22. A computer implemented method according to claim 21, wherein said data indicative of a previously performed sequence indicates a probability of meeting the content provision parameter if at least one of the first content data, the second content data and/or the further content data was to be selected.

23. A computer implemented method according to claim 1, wherein at least one of the first content data, the second content data and the further content data is representative of a group of content items to be used by the computing device together.

24. A computer implemented method according to claim 1, where at least one of the first content data, the second content data and the further content data is representative of a series of content items to be used consecutively by the computing device.

25. A computer implemented method according to claim 1, wherein data indicative of at least one preference for providing content data to the computing device is used in at least one of said selecting of the first content data, said selecting of the second content data and said selecting of the further content data.

26. A computer implemented method according to claim 25, wherein said data indicative of at least one preference for providing content data to the computing device is at least partly generated on the basis of an action at the computing device in relation to the at least one first content item, the at least one second content item and/or the at least one further content item.

27. A computer implemented method according to claim 25, wherein said data indicative of at least one preference for providing content data to the computing device is at least partly generated before commencing the sequence.

28. A computer implemented method according to claim 1, wherein at least one of said selecting of second content data and said selecting of further content data includes selecting content data from content data representative of a plurality of content items and/or selecting content data representative of a modification to be made to a content item represented by content data previously provided to the computing device.

29. A computer implemented method of controlling provision of content data representative of at least one content item, the content data being provided according to a sequence determined in accordance with content provision parameter data indicative of at least one content provision parameter, the sequence being determined in accordance with action data indicative of an action at a computing device in relation to content data provided during the sequence, the method including:
receiving at the computing device first content data representative of at least one first content item, in accordance with a first part of said sequence;
providing first action data indicative of an action at said computing device in relation to said first content data;
receiving selected second content data, representative of at least one second content item, at the computing device in accordance with a second part of the sequence, the second part of the sequence having been determined by selecting the second content data using data indicative of an assessed state of the computing device, the assessed state of the computing device having been determined by processing said first action data with the content provision parameter data to assess a state of said computing device in relation to the at least one content provision parameter;
providing second action data indicative of an action at said computing device in relation to said second content data; and
receiving at the computing device selected further content data, representative of at least one further content item, if it has been determined to select and provide the further content data in accordance with at least one further part of the sequence, the at least one further part of the sequence having been determined using data indicative of a further assessed state of the computing device, the further assessed state of the computing device having been determined by processing said second action data with the content provision parameter data to assess further a state of said computing device in relation to the at least one content provision parameter.

30. Apparatus for controlling provision of content data representative of at least one content item, the apparatus comprising:
at least one processor;
and at least one memory including computer program instructions;
the at least one memory and the computer program instructions being configured to, with the at least one processor, cause the apparatus at least to perform:
a computer implemented method of controlling provision of content data representative of at least one content item, the content data being provided according to a sequence determined in accordance with content provision parameter data indicative of at least one content provision parameter, the sequence being determined in accordance with action data indicative of an action at a computing device in relation to content data provided during the sequence, the method including:
providing first content data representative of at least one first content item to the computing device, in accordance with a first part of said sequence;
receiving first action data indicative of an action at said computing device in relation to said first content data;
processing said first action data with the content provision parameter data to assess a state of said computing device in relation to the at least one content provision parameter;
determining a second part of the sequence, using data indicative of said assessed state of the computing device, by selecting second content data representative of at least one second content item,
providing said selected second content data to the computing device, in accordance with the second part of the sequence;
receiving second action data indicative of an action at said computing device in relation to said second content data;
processing said second action data with the content provision parameter data to assess further a state of said computing device in relation to the at least one content provision parameter; and
determining at least one further part of the sequence, using data indicative of said further assessed state of the computing device, by determining whether the at least one content provision parameter is met or whether to select and provide the computing device with further content data representative of at least one further content item.

31. A computer program product comprising a non-transitory computer-readable storage medium having computer readable instructions stored thereon, the computer readable instructions being executable by a computerized device to cause the computerized device to perform a computer implemented method of controlling provision of content data representative of at least one content item, the content data being provided according to a sequence determined in accordance with content provision parameter data indicative of at least one content provision parameter, the sequence being determined in accordance with action data indicative of an action at a computing device in relation to content data provided during the sequence, the method including:
providing first content data representative of at least one first content item to the computing device, in accordance with a first part of said sequence;
receiving first action data indicative of an action at said computing device in relation to said first content data;
processing said first action data with the content provision parameter data to assess a state of said computing device in relation to the at least one content provision parameter;
determining a second part of the sequence, using data indicative of said assessed state of the computing device, by selecting second content data representative of at least one second content item,
providing said selected second content data to the computing device, in accordance with the second part of the sequence;
receiving second action data indicative of an action at said computing device in relation to said second content data;
processing said second action data with the content provision parameter data to assess further a state of said computing device in relation to the at least one content provision parameter; and
determining at least one further part of the sequence, using data indicative of said further assessed state of the computing device, by determining whether the at least one content provision parameter is met or whether to select and provide the computing device with further content data representative of at least one further content item.
